(19) United States
(12) Patent Application Publication
(10) Pub. No.: US 2003/0093165 A1
(43) Pub. Date: May 15, 2003

(54) Programming method for creating a control program of an industrial machine

(76) Inventor: Arthur Thiel, Schieberdingen (DE)

Correspondence Address: BAKER & BOTTS, 30 ROCKEFELLER PLAZA, NEW YORK, NY, 10112

(21) Appl. No.: 10/262,193

(22) Filed: Oct. 1, 2002

(30) Foreign Application Priority Data
Oct. 1, 2001 (DE) 101 48 519.0

(51) Int. Cl. G05B 19/42

(52) U.S. Cl. 700/86; 700/87

(57) ABSTRACT

The invention relates to a programming method for creating a control program for sequences of an industrial machine with a teach-in function, at least one subprogram by which a sequence is initiated during the teach-in is called-up and the subprogram supplying the control program and/or a further subprogram with a code and/or data. Consequently, the functionality of the teach-in is extended by improved subprograms.

The invention relates to a programming method for creating a control program for sequences of an industrial machine by a teach-in method.

### BACKGROUND OF THE INVENTION

One example of a programming method for a control system of an industrial machine is disclosed in the operating instructions “Sinumerik 840D/840DE/810D Operating Instructions AT6 (BAH)—06.00 edition,” Pages 7/86 to 7/98 refer to a “teach-in” function, i.e. programming by demonstration. Programming by means of teach-in allows sentences of the control program to be inserted, altered or substituted, and programs to be corrected with an editor. By means of teach-in, sequences can be programmed by the execution of sequences which serve to create a control program for sequences of an industrial machine. In programming, the programmer executes sequences which are then programmed by the teach-in, for example, circular traversing movements of a machine tool can be inserted into the control program by predefined supplementary functions by prescribing auxiliary points, the movement itself not being executed during the teach-in. However, the fact that the movement itself is not performed means that there is no clearly evident check on the feasibility of such a movement. The attempt to execute movements which are not feasible may lead to hardware being damaged. While supplementary functions may be prescribed for the user or the programmer, they generally cannot be adapted flexibly to different tasks.

### SUMMARY OF THE INVENTION

The object of the present invention is to extend the functionality of the teach-in by providing improved subprograms. This object is achieved by a programming method for creating a control program for sequences of an industrial machine in which the execution of sequences, i.e. teach-in, is used for programming-in these sequences. At least one subprogram initiates a sequence during the teach-in is called-up and the subprogram supplies the control program or a further subprogram with a code and/or data.

Apart from editing methods for creating a control program for sequences of an industrial machine, there are also methods in which execution of the sequences is used for programming the sequences into a control program. This operation is also referred to as teaching or teach-in. During the teach-in, one or more subprograms can be called up. At least one subprogram is used for supplying the control program with data, with the subprogram initiating a sequence. Apart from supplying data, supplying at least the control program with a code is also be envisaged. This code is new for the control program and/or a subprogram and contains instructions or commands. A subprogram is also capable of supplying a further subprogram with data. This results in a complexly constructable data supply structure by which, subprograms can be linked with one another in terms of data technology. The data supply can be directed at various functionalities. For example, one subprogram supplies a further program with variables, constants, commands, etc. A sequence of the industrial machine called-up by the sequence of a subprogram is taught into the control program, for example at least in parts of said sequence, each program capable of running on the NC is a parts program in the classic way.

A further function of the subprogram is, for example, the initiation of a sequence by which data with which the control program is supplied are obtained, for example measuring results. Measuring results may be the position of objects or else the measurement of a surface quality. If, for example, in the case of a surface it is required to determine its planarity, a subprogram is capable of establishing this and transferring the value of the planarity to the control program as a constant. The degree of planarity is a variable parameter which is established during the teaching operation in order to supply the control program with these data on planarity. Within the control program, these data are fixed parameters and constant. Planarity is an example of a variable value, as are also other variable parameters which describe a state of the industrial machine and are fixed in their value by a subprogram at the value which they have during the execution of the subprogram and which is transferred to the control program as a constant.

A further approach to achieving the object of the present invention derives from a programming method for creating a control program for sequences of an industrial machine in which the execution of sequences is used for programming-in the sequences, i.e. by teach-in, at least one subprogram being called up during the teach-in, and the subprogram supplying the control program and/or a further subprogram with a code and/or selectable data.

A programming method which programs in the sequences by executing sequences, i.e. by teach-in, is used for creating a control program for sequences of an industrial machine. Such a programming method can be combined with other programming methods. These are to be understood as meaning, for example, programming methods which edit the control program textually, such as for example in the case of an instruction list, or graphically, such as for example when programming with functional modules. Apart from the instruction lists, also known as AWL, functional-module-based programming languages, for which the term FUB is denotative, programming languages with contact plans, KOP, or structured-text programming languages ST, or high-level languages such as C++ are known. By the teach-in programming method, the execution of a sequence is used for programming the sequence. During the teach-in program, at least one subprogram is called up. This subprogram supplies the control program and/or a further subprogram with selectable data. The selected data are transferred to the control program and/or a further subprogram, the selection either being predetermined by the subprogram and/or taking place by the programmer. By supplying or transferring the data to the control program and/or a further subprogram, these programs are supplied with values and/or also edited. The possibility of selection of the data makes the function of the subprogram highly variable. The direct supply of data makes a manual data transfer by the user or the programmer between the subprogram and another program superfluous. Current states of the industrial machine and/or current parameters of the subprogram can be fixed.

In a preferred manner of carrying out the programming method, at least one parameter of the industrial machine is provided as data at the time at which the subprogram is executed. An industrial machine has different parameters. State parameters describe the state of the industrial machine, such as for example position values, speeds, rotational speeds or accelerations. Other parameters include calculated parameters such as a characteristic number for an imbalance, or parameters with which the industrial machine itself has been supplied. Such supplied parameters can be carried out by other industrial machines, control devices, data-processing machines or a device for data input, known as a man-machine interface MMI, which comprises, for example, data concerning the position of a workpiece. Accordingly, at least one parameter of an industrial machine is transferred with its value at the time of execution of the subprogram to the control program and/or a further subprogram. In this way, a parameter can be frozen in its value and is taken over into other programs as a constant. A variable can also be transferred at the time of execution of the subprogram as a parameter of the industrial machine. If the control program and/or a further subprogram is supplied with a variable parameter, the latter is not assigned a constant value at the time of execution of the subprogram. The subprogram called up during the teach-in operation can be executed in such a way that it also transfers data concerning commands to a further program, so that the other program is extended by new executable commands.

Supplying data or the transfer of data is not restricted merely to parameters but also relates to at least one instruction which is transferred to the control program and/or a further subprogram. Instructions are, for example, commands and/or sets of commands such as allocations or computing operations.

In a preferred method, at least one call-up of a subprogram is provided as an instruction. By supplying the control program and/or a further subprogram with the call-up of a subprogram, very complex structures can be constructed. These can be variably formed. Such a supplied subprogram can also be combined with supplying parameters and/or instructions. For instance, input parameters of the subprogram to be called up can be supplied along with variables and/or constants.

In a further preferred method, programming is provided for the subprogram. The programming of a subprogram and/or plurality of subprograms allows them to be used very variably. The data which serve for supplying a control program and/or a further subprogram are flexibly selectable. In addition, further operations with respect to the processing of data can be programmed within the subprogram. The programming methods that are available for the programming of the control program are also available for the programming of the subprogram. Apart from the graphic or textual programming methods, these are also the learning programming methods such as teach-in. The transfer of data from one subprogram to another subprogram allows nested subprogram call-ups to be executed, the transferred data respectively denoting a group of subprograms or a special subprogram, which is then executed.

In another preferred method, at least part of the subprogram is programmed by teach-in. To make the programming of a subprogram easier for a programmer or a user, subprograms can also be taught. This is advantageous in particular in the case of complex subprograms. Since the teach-in method allows simple and quick programming, and does so even for poorly trained personnel as users or as programmers, subprograms are also just as easy to program as control programs themselves.

In another preferred method, a calculation is performed by the subprogram, at least one result of which is being transferred from the subprogram to a further subprogram and/or to the control program. Subprograms can perform calculations which supply interim results and/or results which serve for supplying data to a further program, i.e. a control program and/or a further subprogram. The use of a subprogram for calculating coordinate transformations, for example, allows calculations which keep recurring to be effectively executed.

In another preferred method, the subprogram carries out at least one measuring operation and at least one result of which is transferred into a further subprogram and/or into the control program. During the teach-in operation, states, for example with respect to positions and/or conditions of a workpiece or a production item, can be measured and the resulting values can be transferred as constant values into another program.

In a further preferred method, an orientation and/or a reference system is created by the subprogram, data from which is transferred into a further subprogram and/or into the control program. Within a subprogram, new reference systems or orientations can be created. This creation is performed for example by coordinate transformation. This is particularly advantageous in particular whenever, for example in the case of machine tools, new machining levels are introduced. This makes handling and clear programming very much easier, so that the programming is performed much more quickly, easily and/or reliably by the user or the programmer.

In yet another preferred use, the programming method is used for industrial machines with a numerical control system. The programming method requires a device on which programs are capable of running. If an industrial machine already has such a device for data processing, such as is the case for example with a numerical control system, the inventive programming method can be combined with a numerical control system. Industrial machines are to be understood as meaning, for example, machine tools, production machines and/or handling automatons. Handling automatons are, for example, robots, with which teach-in methods are already used in many cases for programming.

### BRIEF DESCRIPTION OF THE DRAWINGS

The present invention is described herein below in the context of drawings in which several embodiments of the programming method are schematically illustrated.

FIG. 1 illustrates a first program structure in a schematized form;

FIG. 2 illustrates a cuboid as an application example for the programming method;

FIG. 3 illustrates a development of the cuboid from FIG. 2;

FIG. 4 schematically illustrates a second program structure;

FIG. 5 illustrates a subprogram;

FIG. 6 schematically illustrates a third program structure; and

FIG. 7 schematically illustrates a fourth program structure.

### DETAILED DESCRIPTION OF THE INVENTION

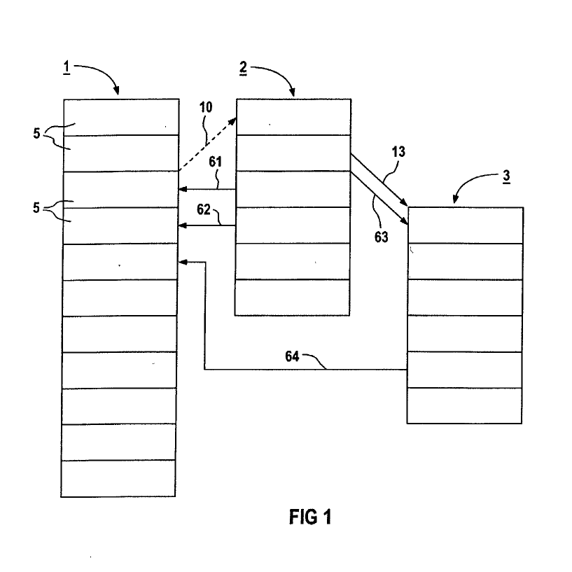

FIG. 1 shows a combination of a parts program 1 and two subprograms 2 and 3. The programs 1, 2, 3 are subdivided into program sections 5 which are auxiliary means for the schematic representation of the interlinkage between the programs 1, 2, 3, and for the representation of sections of command steps. The subprogram 2 is called-up between two program sections 5 of the parts program 1 via an asynchronous subprogram call-up 10, the asynchronicity is illustrated in FIG. 1 by the dashed lines of the arrow. The subprogram call-up 10 is asynchronous because it can be initiated, for example by a user or a programmer, during the running of the parts program 1. When the subprogram 2 is triggered, the control program has a current position. At this position, code can be inserted by at least one subprogram. The subprogram 3 is called-up by a subprogram call-up 13 from the subprogram 2. This call-up takes place synchronously from a program section 5 of the subprogram 2, the processing of the subprogram 2 then stops temporarily until the subprogram 3 has been processed. Synchronity arises from the call-up from the subprogram 2. Data, such as for example values of variables and/or codes, i.e. instructions or commands, can be exchanged between the programs 1, 2, 3. The supplied code and/or supplied data 61 constitutes a data transfer in which a value of at least one variable is transferred from the subprogram 2 to the parts program 1. The supplied code and/or supplied data 62 constitutes, a data transfer in which the subprogram 2 adds to the parts program 1 an entire program section with commands. With the supplying of code and/or data 61 and 62, code is inserted after the current position of the parts program. The subprogram 2 is also capable of supplying the subprogram 3 with data and/or code, as is represented by the supplied code and/or data 63. The subprogram 3 in turn has supplied code and/or data 64 for the parts program 2, which is the control program.

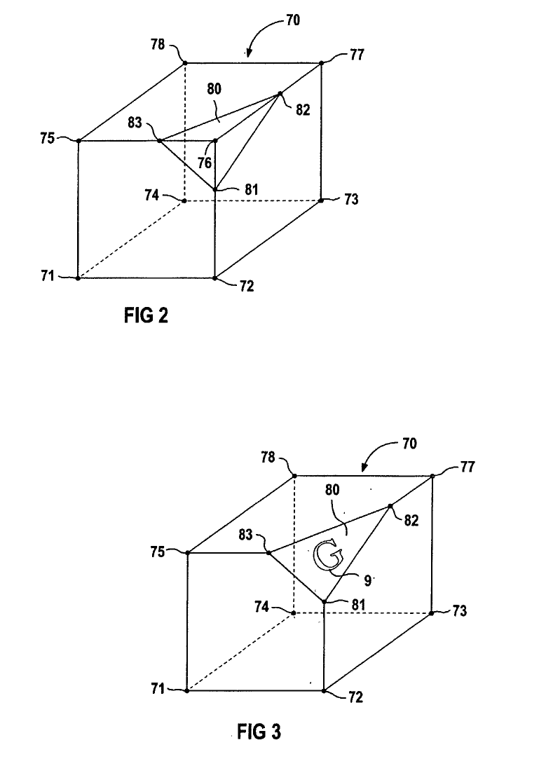

FIG. 2 shows in conjunction with the representation according to FIG. 3 an example of the advantageous application of a subprogram within a teach-in operation. FIG. 2 shows a cube 70 in a perspective representation with eight corners 71, 72, 73, 74, 75, 76, 77, 78. The task of a control program of an industrial machine is, for example, to remove the cube corner 76 in such a way that the removal of material produces a triangular area 80 with the triangle points 81, 82 and 83.

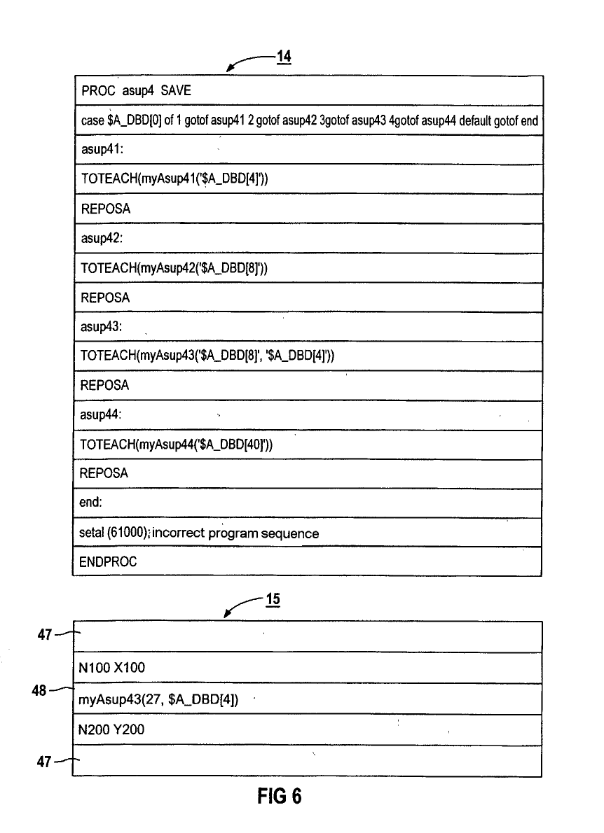

FIG. 3 shows the cube 70 according to FIG. 2 with seven cube corners 71, 72, 73, 74, 75, 77, 78 and three triangle points 81, 82, 83. The triangle points 81, 82, 83 define a triangular area 80. On the triangular area 80 there is an engraving 9 in the form of the letter “G”. If the cube 70 is located as a workpiece in a machine tool, or if the cube 70 is the workpiece of a handling automaton, for example a robot, and if the cube 70 is aligned within the respective reference system of the industrial machine, it is easily possible for both a machine tool and an arm of the handling automaton to move to the cube corners 71, 72, 73, 74, 75, 77, 78. This capability advantageously results from the identical orientation of the reference systems of the industrial machine with a reference system, or a system of reference coordinates along the longitudinal sides of the cube 70. For example, the connections between the cube corner 71 and the cube corner 72, the cube corner 71 and the cube corner 74 and the cube corner 71 and the cube corner 75 define an orthogonal system of coordinates. Within such a system of coordinates, it is also easy for a user or programmer to move to the triangle points 81, 82, 83 on the cube 70. Consequently, no major difficulties arise for creating the triangular area 80. If the triangular area 80 is then to be provided with an engraving 9 which represents the letter G, there then arises for the user or the programmer of the industrial machine the difficulty of programming within the triangular area 80 lying obliquely with reference to the orientation system of the industrial machine. The programming of the engraving 9 is made easier by rotation or transformation of the reference system of coordinates into the triangular area 80. The triangular area 80 advantageously lies in a plane which is defined by two axes of a Cartesian, orthogonal system of coordinates. For example, the connection between the triangle point 83 and the triangle point 81 advantageously lies on an axis of the transformed system of coordinates. The orientation of the triangular area 80 is determined by a subprogram started in the teach-in operation by moving to the triangle points 81, 82 and 83 and transferring the coordinate transformation into the parts program. FIG. 6 schematically shows the sequence of such an operation.

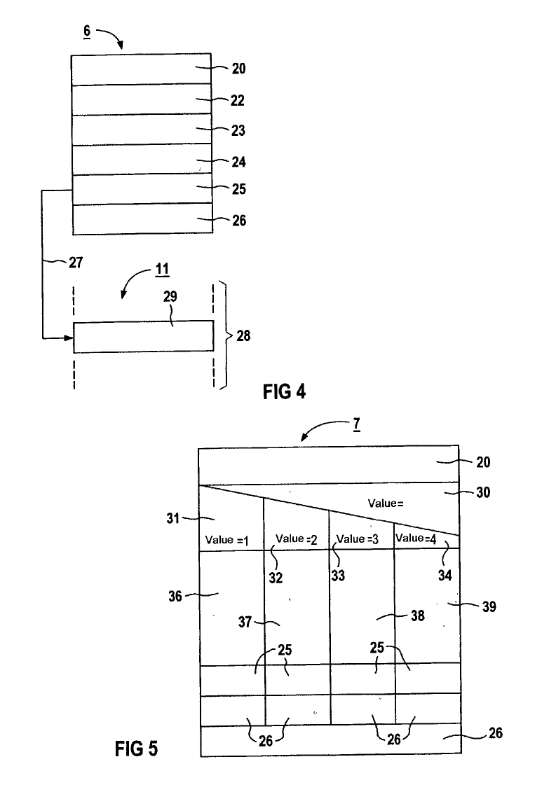

FIG. 4 shows a subprogram 6 with program sections as the start of the subprogram 20, measuring cycle 22, intermediate step 23, coordinate transformation 24, set of transfer commands 25, and the end of the program 26, and a control program 11. The first program section 5 is the start of the subprogram 20. The second program section is a measuring cycle 22, which measures for example the orientation of an object within the reference system of the industrial machine. The measuring cycle 22 may accordingly be followed by various intermediate steps 23, only one intermediate step 23 being shown in FIG. 4. If the result of the measuring cycle 22 is an oblique orientation of an object within the reference system of the industrial machine, a coordinate transformation 24 can be envisaged. The transformation of the coordinates is transferred by means of a program section as a set of commands in relation to the coordinate transformation as supplied code and/or data 27 to a control program 11 (only a detail of which is represented) into a program section as a program command line 29. The program command line 29 is a new addition to a program section sequence 28. The subprogram 6 generates within the control program 11 a program section which contains the program command line 29 already written in the subprogram 6. The control program 11 has thus been edited by the subprogram 6.

FIG. 5 shows a subprogram 7. In the structured representation according to FIG. 5, the capability of a subprogram to call-up further subprograms 36, 37, 38 and 39 is shown by way of example. After the start of the subprogram 20 there follows a “value=” criterion inquiry 30 as to whether a variable with the designation “value” assumes the value 1, 2, 3 or 4. If the “value=1”, the subprogram 36 is to be processed. If the “value=2”, the subprogram 37 is to be processed. If the “value=3”, the subprogram 38 is to be processed. If the “value=4”, the subprogram 39 is to be processed. A subprogram 7 thus branches to different subprograms 36, 37, 38 and 39. As already described, these subprograms 36, 37, 38 and 39 have for their part a set of transfer commands 25 to a control program or a further subprogram. The subprograms 7, 36, 37, 38 and 39 have an end of program 26.

FIG. 6 shows a target-oriented subprogram, 8 with a program call-up 41 of an asynchronous subprogram with the designation “MessAsup”: “PROC MessAsup SAVE”. In this case, “PROC” is a symbol for a procedure head, “MessAsup” is the name of the procedure, i.e. of the program, and “SAVE” is the designation of a G function. G functions are restored after completion. If, for example, an asynchronous subprogram, which can also be referred to as Asup, switches over with a parts program command G91 to incremental programming, “SAVE” switches back again to absolute programming after the end of Asup, depending on what was set in the main program, for example: incremental programming on the current position X=377 GO X100;→machine moves to 477 absolute programming on the current position X=377 GO X100;→machine moves to 100.

The subprogram can be referred to as an asynchronous subprogram, since this subprogram can be called-up asynchronously within the sequence of the control program. The user or programmer can asynchronously start a different subprogram during the programming of the control program or after the programming of the control program in the sequence of the latter. This operation is associated with the teaching mode. The program call-up 41 is followed by the execution of a measuring cycle 42, which is not referred to in any greater detail. The space-saver 47 symbolically shows that the subprogram 8 may comprise more than the program sections represented. The space-saver 47 is followed, for a machine tool for example, by the alignment of a milling cutter, this milling alignment 43 being followed by a further space-saver 47 and a frame rotation 44. FIGS. 2 and 3 serve to make this example understandable. The measuring cycle 42 measures, for example, the orientation of the triangular area 80. With the milling alignment 43, the alignment of a milling cutter for milling the triangular area 80 is performed. The frame rotation 44 specifies the rotation of the system of coordinates, i.e. the coordinate transformation. With the set of transfer commands 45, the command “TOTEACH” is used to write the command, i.e. the code “$P_FRAME=$P_FRAME: CROT(X, ‘$AA_IW(B)’,Z, ‘$AA_IW(A)’)”, into the control program and insert it there as subprogram editing 48 between the program section with the content “N100 X100” and the program section with the content “N200 Y200”. The expressions used in the above command with the leading $ symbol specify variables. By the use of backquotes ”, the parts of TOTEACH which are being evaluated can be determined before they are taken over. Consequently, variables which represent the states of the machine can be taken over as constants into the program to be taught. The expression “CROT” that is used specifies a rotation command for the given axes “X” and “Z”. The command referred to is an instruction which rotates a current frame in an x axis by the value “$AA_IW(B)”, i.e. the current value of an axis B, and also rotates it in a z axis of the current frame by the value from “$AA_IW(A)”, i.e. the actual value of an axis A. For supplying data to the control program 12, the variables “$AA_IW(B)” and “$AA_IW(A)”, which stand for the value of the current angle of rotation of two axes B and A, are used. The values “$AA₁₃ IW(A)” and “$AA_IW(B)” are angles in degrees. In the control program 12 there is then the following subprogram editing 48: “$P_FRAME=$P_FRAME: CROT (X, 45.0, Z, 45.0)” after the control system has determined for “$AA_IW(B)” the value 45 as data. The same also applies correspondingly to “$AA₁₃ IW(A)”. The expression “FRAME” is a linear specification for mapping one system of coordinates into another. This mapping specification scales, rotates, reflects and displaces the programmed paths.

In the expression in parentheses after the command “TOTEACH”, the parts of the instruction which are being evaluated first, before the expression is taken over into the teaching program, i.e. the parts program, are enclosed in backquotes. With this technique, their current value is frozen and it enters the teaching program as a constant. Consequently, generally current machine states are frozen. If the instruction “$P_FRAME=$P_FRAME: CROT(X, ‘$AA_IW(B)’,Z, ‘$AA IW(A)’)” is related to FIG. 2, it can be assumed that the axes A and B have been positioned perpendicularly upright on the area 80. This can take place automatically by the Asup or be ensured by manual interventions. The current axial positions of A and B then determine the new rotation. The command “M17” stands for the subprogram return. The expression “ENDPROC” is the closing parenthesis for the command PROC and ends the subprogram 8.

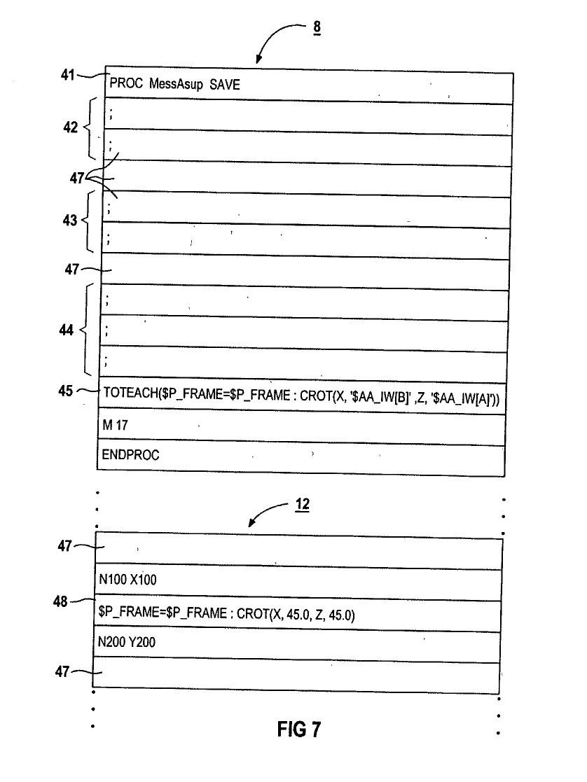

FIG. 7 shows a subprogram 14 and a control program 15. The subprogram 14 with the name “asup4” performs the task of selecting a subprogram from a plurality of available subprograms “myAsup41”, “myAsup42”, “myAsup43” and “myAsup44”, and supplying the control program 15 with data in the form of variables, such as “$A_DBD(4)”, or in the form of constants such as “27”=“A_DBD(8)”.

With the program call-up “PROC asup4 SAVE”, the subprogram asup4 is started. This is followed by the program line “case $A_DBD(0) of 1 gotof asup41 2 gotof asup42 3 gotof asup43 4 gotof asup44 default gotof end”.

After that, depending on the value of the variable “$A_DBD(0)”, a jump is made to “asup41” when “$A_DBD(0)=1”, to “asup42” when “$A_DBD(0)=2”, to “asup43” when “$A DBD(0)=3”, and to asup44” when “$A DBD(0)=4”. In other words, branching takes place according to the content of the variable $A DBD(0). If the variable is 1, jump to the program branching destination asup41; if the variable is 2, jump to the program branching destination asup42; if the variable is 3, jump to the program branching destination asup43; if the variable is 4, jump to the program branching destination asup44; if the variable is another value, jump to the program branching destination end.

In the branching region “asup41:” there is the command:

“TOTEACH (myASUP41(‘$A_DBD(4)’))”. Behind the command “TOTEACH” there is in parentheses ( ) the expression which is to be inserted into the control program 15. The branching region is terminated by the command: “REPOSA”.

The branching region asup41 is followed in a similar way by the branching regions: “asup42:” “TOTEACH (myASUP42(‘$A_DBD(8)’))” “REPOSA”; “asup43:” “TOTEACH (myASUP43(‘$A_DBD(8)’, $A₁₃ DBD(4)))” “REPOSA”; “asup44:” “TOTEACH (myASUP44 (‘$A_DBD(40)’))” “REPOSA”.

The command lines: “end:”; “setal (61000); incorrect program call-up; and “ENDPROC” end the subprogram 41.

The command “setal” stands for “set alarm”, so that an alarm is set. In a program line behind the “;” there is a comment, such as for example “incorrect program call-up”.

The command “REPOSA” specifies a special subprogram end for asups, i.e. for asynchronous subprograms, which allows return to a contour, also known as repositioning.

On the assumption that in the subprogram 14 “$A_DBD(0)=3” and that for the system “$A_DBD” it is the case that “$A_DBD(8)=27”, and that the call-up of the subprogram “asup4” takes place after the program line “N100 X100” and before the program line “N200 Y200” in the control program, there is obtained between these program lines the program line inserted from the subprogram “myASUP43 (27, $A_DBD(4))”. System variables in the NC can be set externally.

The aforegoing examples illustrate the flexibility of the programming method according to the present invention with the flexibly formable subprograms.

I claim:

1. A programming method for creating a control program for sequences of an industrial machine comprising using execution of the sequences, i.e. teach-in for programming-in said sequences, calling-up at least one subprogram which initiates a sequence during the teach-in, wherein the subprogram supplies the control program and/or a further subprogram with a code and/or data.

2. A programming method for creating a control program for sequences of an industrial machine comprising using the execution of sequences, i.e. teach-in, for programming-in said sequences; calling-up at least one subprogram during the teach-in, wherein the subprogram supplies the control program, and/or a further subprogram with a code and/or selectable data.

3. The programming method according to claim 1 and 2, further comprising providing at least one parameter of the industrial machine at the time at which the subprogram is executed.

4. The programming method according to claims 1 and 2, further comprising providing at least one instruction as data.

5. The programming method according to claim 4, wherein at least one call-up of a subprogram is provided as an instruction.

6. The programming method according to claims 1 and 2, further comprising providing programming for the subprogram.

7. The programming method according to claim 6, further comprising programming at least part of the subprogram by teach-in.

8. The programming method according to claims 1 and 2, further comprising having the subprogram perform a calculation, at least one result of the calculation being transferred from the subprogram to a further subprogram and/or to the control program.

9. The programming method according to claims 1 and 2, further comprising having the subprogram carry out at least one measuring operation, and at least one result of the measuring operation being transferred to a further subprogram, and/or into the control program.

10. The programming method according to claims 1 and 2, further comprising having, characterized in that the subprogram create an orientation and/or a reference system, wherein data from this creation are transferred into a further subprogram, and/or into the control program.

11. The programming method according to claims 1 and 2 as applied to a numerical control system provided for the industrial machine.
